(19) United States
(12) Patent Application Publication
(10) Pub. No.: US 2014/0349826 A1
(43) Pub. Date: Nov. 27, 2014

(54) CENTRIFUGE

(71) Applicant: HITACHI KOKI CO., LTD., Tokyo (JP)

(72) Inventor: Shinichi Haruki, Ibaraki (JP)

(73) Assignee: HITACHI KOKI CO., LTD., Tokyo (JP)

(21) Appl. No.: 14/284,593

(22) Filed: May 22, 2014

(30) Foreign Application Priority Data
May 27, 2013 (JP) 2013-110890

(51) Int. Cl. B04B 15/08

(52) U.S. Cl. CPC B04B 15/08
USPC 494/1; 494/26; 494/23

(57) ABSTRACT

A centrifuge including: a rotary chamber; a rotor installed in the rotary chamber; a driving unit configured to rotate the rotor; a chamber accommodating the rotary chamber, having a door, and configured to house gas therein; and a vacuum pump apparatus configured to exhaust the gas inside the chamber to an outside of the chamber, wherein the chamber is provided with a plurality of gas inlets and a plurality of valves configured to respectively open and close the gas inlets, and wherein all of the plurality of valves are configured to be opened when bringing an internal pressure of the chamber to atmospheric pressure.

### CROSS-REFERENCE TO RELATED APPLICATIONS

This application claims priority from Japanese Patent Application No. 2013-110890 filed on May 27, 2013, the entire contents of which are incorporated herein by reference.

### TECHNICAL FIELD

The present invention relates to a centrifuge for decompressing a chamber including a rotor rotary chamber, and particularly, relates to a configuration for decompressing a chamber and then returning an internal pressure of the chamber to atmospheric pressure.

### BACKGROUND

By holding samples stored in tubes or the like by a rotor, disposing the rotor in a rotor rotary chamber which is decompressed so as to prevent temperature from rising due to windage loss of the rotor, and rotating the rotor at a high speed by a driving device configured by an electric motor or the like, a centrifuge centrifuges the samples held in the rotor.

In general, in a so-called ultracentrifuge in which the rotation speed of the rotor exceeds 40,000 rpm, as disclosed in JP-A-2001-104826, in order to suppress temperatures of the rotor and samples from rising due to frictional heat attributable to windage loss of the rotor and air in the rotor rotary chamber according to rotation of the rotor, the ultracentrifuge includes a vacuum pump apparatus and a vacuum pressure detecting means. The vacuum pump apparatus decompresses the rotor rotary chamber until the rotor rotary chamber becomes a high vacuum state. The vacuum pressure detecting means includes a sensor and a sensor detecting circuit and detects a vacuum pressure of the inside of the rotor rotary chamber.

The vacuum pump apparatus for decompressing the rotor rotary chamber from atmospheric pressure to the high vacuum state has a configuration in which an auxiliary vacuum pump for decompressing the rotor rotary chamber from atmospheric pressure to medium vacuum of about 13 Pa and an oil diffusion pump for decompressing the rotor rotary chamber from the medium vacuum to high vacuum of about 1 Pa are connected in series. In order to suppress the temperatures of the rotor and samples from rising due to frictional heat attributable to windage loss of the rotor and air in the rotor rotary chamber according to rotation of the rotor, in general, a so-called vacuum waiting operation for rotating the rotor at a predetermined low rotation speed, for example, at 5,000 rpm is performed until the inside of the rotor rotary chamber is decompressed from atmospheric pressure to medium vacuum of, for example, about 13 Pa by the vacuum pump apparatus. After the rotor rotary chamber reaches the medium vacuum, the rotor is accelerated to tens of thousands rpm to hundreds of thousands rpm, whereby centrifuging is performed.

Alternatively, in a case where a rise in the temperature of a sample due to windage loss according to rotation of the rotor is desired to be minimized, in order to centrifuge the sample, a so-called vacuum start operation in which the rotor is rotated for the first time after the rotor rotary chamber reaches the medium vacuum of about 13 Pa is performed.

In this kind of centrifuge having a vacuum pump apparatus as described above, the centrifuge includes a rotor rotary chamber that has a smooth surface for minimizing windage loss according to rotation of a rotor, and a chamber (a vacuum container) that accommodates the rotor rotary chamber and evacuates the rotor rotary chamber and the periphery of the rotor.

In the chamber, as disclosed in JP-A-H09-75782, there are provided a door that is opened and closed to install or take out the rotor, a driving unit that rotates the rotor, a vacuum apparatus that evacuates the chamber, a pressure sensor that detects the vacuum pressure of the chamber, and an atmospheric-pressure air inlet that is connected to a valve which introduces air inside the chamber when bringing the internal pressure of the chamber to the atmospheric pressure and seals the chamber when evacuating the chamber.

In order to take out the rotor having finished centrifuging from the rotor rotary chamber, wit is general to stop the vacuum apparatus while rotation of the rotor is decelerated. After the rotation of the rotor stops, the valve connected to the atmospheric-pressure air inlet formed to the chamber is opened to introduce air into the chamber, and the door is opened when the internal pressure of the chamber becomes atmospheric pressure so as to take out the rotor from the rotor rotary chamber provided in the chamber.

### SUMMARY

In this kind of centrifuge having the above described chamber, in order to take out the rotor, an outlet having a large diameter (a diameter of 50 cm) is necessary. Immediately after the rotor stops, a pressure of about 20,000 N is applied to a door provided to the outlet due to atmospheric pressure. Therefore, unless air is introduced into the chamber so as to completely return the inside of the chamber to atmospheric pressure, it is not possible to open the door.

Also, as the valve for opening or closing the atmospheric-pressure air inlet of the chamber, an electromagnetic valve is used. The electromagnetic valve is configured to be opened or closed by a switch provided to an operation panel of the centrifuge. Also, for safety purposes, the electromagnetic valve is configured so as not to be opened unless the rotor completely stops.

Also, as the electromagnetic valve, a general-purpose electromagnetic valve for pipes having inside diameters of ¼ inches (1 inch is 25.4 mm) to ⅜ inches is used. Even if an electromagnetic valve for large-diameter pipes having inside diameters of ⅜ inches is used to bring the internal pressure of the chamber to atmospheric pressure, in an example, about 40 seconds are required. However, the time of 40 seconds is long for an analyst wanting to take out the rotor including centrifuged samples from the centrifuge. Therefore, in order to improve operability, it is required to reduce the waiting time.

In order to solve these problems, it can be considered to increase the inside diameter of the atmospheric-pressure air inlet and the size of an orifice which is provided at a portion of the electromagnetic valve through which air passes, thereby reducing the total pipe resistance of an atmospheric pressure air introduction portion, increasing air flow, and reducing the time necessary to bring the chamber to atmospheric pressure. However, in a case of increasing the pipe diameter of the atmospheric-pressure air inlet, the electromagnetic valve using the atmospheric-pressure air inlet also becomes bigger. Also, if a pipe is lengthened in order to secure an installation space, the total pipe resistance increases according to the length of the pipe, and thus the time necessary to bring the internal pressure of the chamber to atmospheric pressure can not be reduced.

An object of the present invention is to provide a centrifuge capable of overcoming the above described problems of the related art and increasing the internal pressure of the chamber to atmospheric pressure in a short time after rotation of the rotor stops such that it is possible to take out the rotor from the inside of the rotary chamber storing the rotor in a short time.

According to an aspect of the present invention, there is provided a centrifuge including: a rotary chamber; a rotor installed in the rotary chamber; a driving unit configured to rotate the rotor; a chamber accommodating the rotary chamber, having a door, and configured to house gas therein; and a vacuum pump apparatus configured to exhaust the gas inside the chamber to an outside of the chamber, wherein the chamber is provided with a plurality of gas inlets and a plurality of valves configured to respectively open and close the gas inlets, and wherein all of the plurality of valves are configured to be opened when bringing an internal pressure of the chamber to atmospheric pressure.

According to another aspect of the present invention, there is provided a centrifuge including: a rotary chamber; a rotor installed in the rotary chamber; a driving unit configured to rotate the rotor; a chamber accommodating the rotary chamber, having a door, and configured to house gas therein; and a vacuum pump apparatus configured to exhaust the gas inside the chamber to an outside of the chamber, wherein the chamber is provided with a gas inlet and a valve configured to open and close the gas inlet, and wherein the gas inlet is configured to be supplied with compressed gas.

Accordingly, after rotation of the rotor installed in the rotary chamber stops, it is possible to increase the internal pressure of the chamber accommodating the rotary chamber to atmospheric pressure in a short time. As a result, it is possible to take out the rotor from the inside of the rotary chamber accommodating the rotor in a short time.

### BRIEF DESCRIPTION OF DRAWINGS

FIG. 1 is a view illustrating the configuration of a centrifuge according to a first embodiment of the present invention;

FIG. 2 is an explanatory view illustrating examples of time variations in the internal pressure of a chamber according to different structures for introducing air into the chamber; and

FIG. 3 is a view illustrating the configuration of a second embodiment of the present invention.

### DETAILED DESCRIPTION

Hereinafter, embodiments of the present invention will be described in detail with reference to the accompanying drawings. Components, members, processes, and the like shown in the drawings, which are identical or equivalent to each other, are denoted by the same reference symbol, and repetitive explanation whereof will be omitted as necessary. Also, the embodiments do not limit the invention and are illustrative, and all features to be described in the embodiments and combinations thereof are not necessarily the essential features of the invention.

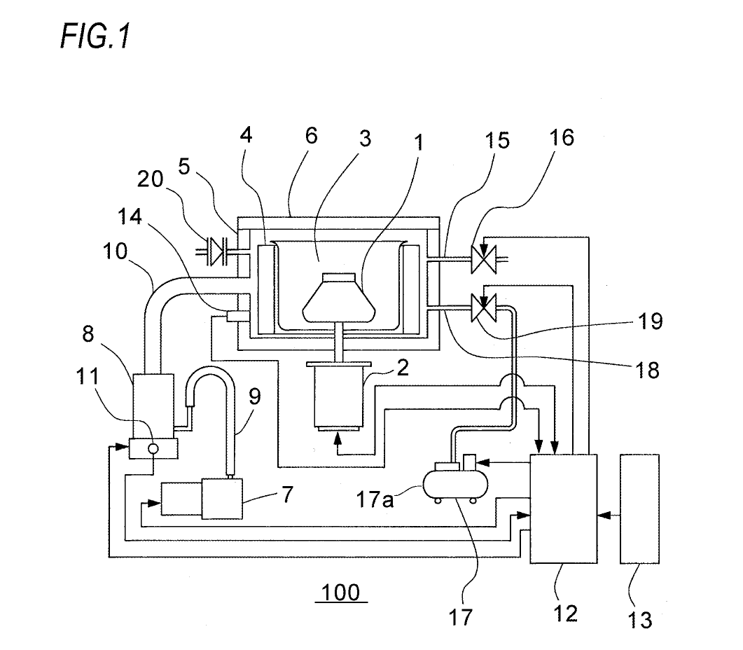

FIG. 1 shows an ultracentrifuge 100 as an example of a centrifuge according to a first embodiment of the present invention. In FIG. 1, the ultracentrifuge 100 includes a rotor 1 for holding samples to centrifuge the samples, a driving unit (a motor) 2 for rotating the rotor 1 at a high speed, a rotor rotary chamber 3 in which the rotor 1 is installed (accommodated), a protector 4 for reducing influence on the entire centrifuge in a case where the rotor 1 is broken down due to its operating life or the like, and a chamber (a vacuum container) 5. The chamber 5 packs (accommodates) the rotor 1, the rotor rotary chamber 3, and the protector 4, and has a door 6 for taking out the rotor 1. In a state where the door 6 is closed, an opening of the chamber 5 is airtightly sealed.

Also, the ultracentrifuge 100 includes a vacuum pump apparatus in which an auxiliary vacuum pump 7 and an oil diffusion vacuum pump 8 are connected in series, in order to exhaust air in the chamber 5 to the outside of the chamber 5 until the chamber 5 becomes a high vacuum state. The auxiliary vacuum pump 7 is an oil rotation vacuum pump, a dry scroll vacuum pump, or the like for decompressing the rotor rotary chamber 3 to medium vacuum of, for example, about 20 Pa, and if an air exhausting operation of the oil diffusion pump starts in the medium vacuum state, the rotor rotary chamber 3 is further decompressed. The oil diffusion pump 8 decompresses the rotor rotary chamber 3 until the rotor rotary chamber 3 becomes high vacuum, and the auxiliary vacuum pump 7 and the oil diffusion pump 8 are connected in series by a vacuum hose 9. The rotor rotary chamber 3 and the oil diffusion pump 8 are connected by a vacuum pipe 10. In order to detect the temperature of the oil diffusion pump 8, a sensor 11 is provided, and the temperature of the oil diffusion pump 8 is detected by the sensor 11, whereby the output of the oil diffusion pump 8 is controlled by a control device 12 of the centrifuge 100. The control device 12 performs control on rotation of the rotor 1, driving and temperature control on the auxiliary vacuum pump 7 and the oil diffusion pump 8, and temperature calculation based on a signal from the sensor 11, and so on. An operation unit (an input unit) 13 is installed for inputting operation conditions or issuing a start or stop command with respect to the control device 12. Also, in order to detect the vacuum pressure of the chamber 5, a vacuum sensor 14 is provided, and on the basis of a signal from the vacuum sensor 14, the control device 12 calculates the degree of vacuum of the rotary chamber 3, and performs vacuum waiting and high vacuum start.

To the chamber 5, there are provided an atmospheric-pressure air inlet 15 for introducing air at atmospheric pressure so as to bring the chamber 5 to atmospheric pressure, and an electromagnetic valve 16 for opening or closing the atmospheric-pressure air inlet 15. If a command for opening and closing the atmospheric-pressure air inlet 15 is issued from the operation unit 13, a signal is transmitted from the control device 12 to the electromagnetic valve 16 and the opening and closing is performed.

The centrifuge 100 further includes an air compressor 17 for generating compressed air. The air compressor 17 includes a pressure container 17a that stores the generated compressed air, and is turned on or off by the control device 12. Specifically, if the pressure container 17a reaches a predetermined pressure, the control device 12 performs control to stop the operation of the air compressor 17. A compressed-air inlet 18 formed to the chamber 5 is connected to the pressure container 17a of the air compressor 17 through an electromagnetic valve 19, and according to a signal transmitted from the control device 12, the electromagnetic valve 19 opens or closes the compressed-air inlet 18. In a case where the inside of the chamber 5 becomes atmospheric pressure or higher due to compressed air supplied from the compressed-air inlet 18, air in the chamber 5 is exhausted from the atmospheric-pressure air inlet 15 to the outside of the chamber 5 through the electromagnetic valve 16. Alternatively, a check valve 20, which seals the chamber 5 in a vacuum state when the inside of the chamber becomes a decompressed state or a vacuum state and exhausts the air inside the chamber 5 when the internal pressure of the chamber 5 becomes the atmospheric pressure or higher, is provided to the chamber 5.

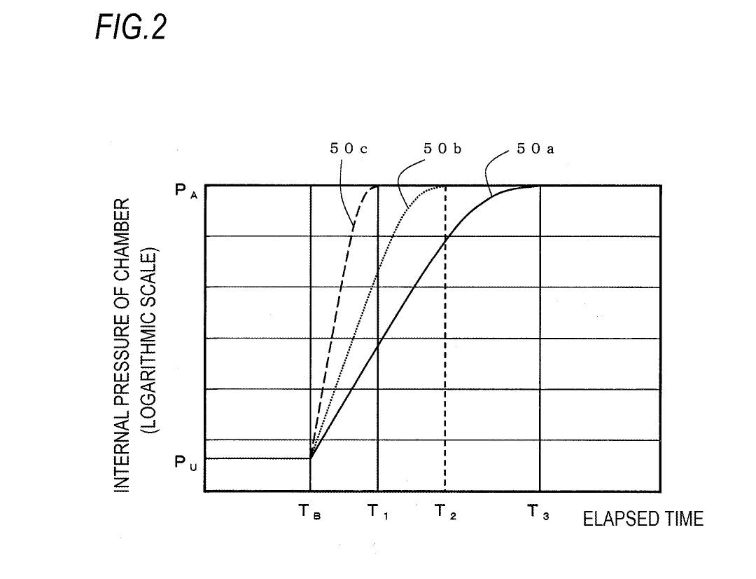

The operation of the first embodiment having the configuration of FIG. 1 will be described with reference to FIG. 2. FIG. 2 shows time variations in the internal pressure of the chamber 5 in a case where air is introduced from the atmospheric-pressure air inlet 15 and the compressed-air inlet 18 from a state where the inside of the chamber 5 was in high vacuum.

The rotor 1 containing samples, which has been rotated at a predetermined rotation speed in the chamber 5 evacuated to high vacuum by the oil diffusion pump 8 and the auxiliary vacuum pump 7 for a predetermined time, is decelerated until the rotor 1 stops. Then, when a rotation sensor provided to the driving unit 2 detects the stop, while the control device 12 stops the oil diffusion pump 8 and the auxiliary vacuum pump 7, thereby stopping evacuating, a display representing that it is possible to introduce air into the chamber 5 is displayed on the operation unit 13.

Meanwhile, while the chamber 5 is in high vacuum, the electromagnetic valve 19 for closing the compressed-air inlet 18 is closed and the air compressor 17 is operated such that compressed air of about 0.7 MPa is stored in the pressure container 17a (for example, a container with a capacity of 3.5 L) provided to the air compressor 17. Then, after a display representing that it is possible to introduce air into the chamber 5 is displayed on the operation unit 13 as described above, when a command for opening a door 6 is input from the operation unit 13, at the same time as the electromagnetic valve 16 connected to the atmospheric-pressure air inlet 15 is opened, the electromagnetic valve 18 intercepting a flow between the pressure container 17a of the air compressor 17 and the compressed-air inlet 18 is opened, whereby air in atmospheric pressure and compressed air are introduced into the chamber 5 at the same time. Variation in the internal pressure of the chamber 5 in this case is shown by a curve 50c of FIG. 1, and only a time (T₁-T_{B}) is required to bring the internal pressure of the chamber from high vacuum (a pressure of P_{U}) to atmospheric pressure (a pressure of P_{A}) at which it is possible to open the door 6. Here, the time T_{B} represents a time at which air starts to be introduced into the chamber 5.

For comparison with the case of the first embodiment, variation in the internal pressure of the chamber 5 until the chamber 5 reaches the pressure of P_{A} in a case of opening only the electromagnetic valve 16 connected to the atmospheric-pressure air inlet 15 so as to introduce air into the chamber 5 according to the related art is shown by a curve 50a of FIG. 2. The curve 50a shows that a time (T₃-T_{B}) is required to bring the internal pressure of the chamber from high vacuum (the pressure of P_{U}) to atmospheric pressure (the pressure of P_{A}). As can be seen from the comparison between the curve 50a and curve 50c of FIG. 2, in the first embodiment, the chamber reaches the pressure at which it is possible to open the door 6 in a shorter time of (T₁-T_{B}) (which is about one third of (T₃-T_{B})) than that in the related art.

According to the present embodiment, it is possible to achieve the following effects.

(1) In introducing air into the chamber 5 when opening the door 6, air compressed by the air compressor 17 is used. That is, it is possible to perform air introduction using high-pressured compressed air. Therefore, it is possible to bring the internal pressure of the chamber 5 to the atmospheric pressure in a shorter time as compared to general air introduction only from one atmospheric-pressure air inlet 15 using a difference in air pressure between the inside and outside of the chamber 5 according to the related art. Therefore, it is possible to reduce a waiting time for opening the door 6.

(2) Air introduction into the chamber 5 uses not only introduction of air compressed by the air compressor 17 but also introduction of air in atmospheric pressure using a difference in air pressure between the inside and outside of the chamber 5. Therefore, it is possible to bring the internal pressure of the chamber 5 to the atmospheric pressure in a further shorter time.

(3) To the chamber 5, the atmospheric-pressure air inlet 15 is formed separately from the compressed-air inlet 18. Therefore, even in a case where compressed air is excessively supplied into the chamber 5 such that the internal pressure of the chamber 5 reaches the atmospheric pressure or higher, it is possible to exhaust air in the chamber 5 from the atmospheric-pressure air inlet 15, thereby preventing an abnormal rise in the internal pressure of the chamber 5.

(4) To the chamber 5, the check valve 20 is provided. Therefore, in a case where compressed air is excessively supplied into the chamber 5 such that the internal pressure of the chamber 5 reaches the atmospheric pressure or higher, it is possible to prevent an abnormal rise in the internal pressure of the chamber 5, and when the electromagnetic valve 16 for the atmospheric-pressure air inlet 15 does not operate, the check valve 20 acts as an alternative safety valve, thereby capable of preventing an abnormal rise in the internal pressure of the chamber 5. As a result, it is possible to further improve safety.

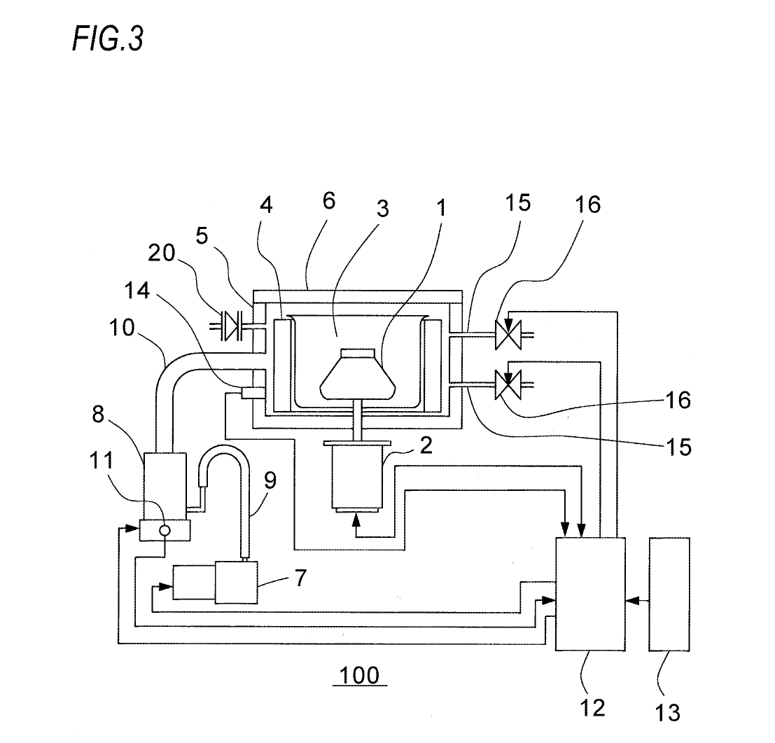

FIG. 3 shows a second embodiment of the present invention. In this case, instead of the compressed-air inlet 18 and the electromagnetic valve 19 for opening and closing the compressed-air inlet 18 of FIG. 1, another atmospheric-pressure air inlet 15 and another electromagnetic valve 16 for opening and closing the another atmospheric-pressure air inlet 15 are provided to the chamber 5.

In order to open the door 6 of the chamber 5, the two atmospheric-pressure air inlets 15 are opened so as to introduce air in atmospheric pressure into the chamber 5. Variation in the internal pressure of the chamber 5 in this case is shown by a curve 50b of FIG. 2. In the curve 50b, a time (T₂-T_{B}) is required to bring the internal pressure of the chamber from high vacuum (the pressure of P_{U}) to atmospheric pressure (the pressure of P_{A}). Therefore, as can be seen from FIG. 2, the required time is sufficiently reduced as compared to the time of (T₃-T_{B}) in the case where one atmospheric-pressure air inlet 15 is open.

Although the invention has been described by reference to the embodiments, it can be understood by those skilled in the art that a variety of modifications can be applied to the components and processes of the embodiments without departing from the scope of the following claims. Hereinafter, modifications will be described.

In each embodiment, three or more inlets for introducing compressed air or air in atmospheric pressure may be formed to the chamber 5.

Further, as a gas to be introduced into the chamber 5, air has been exemplified. However, it is possible to use gases other than air in accordance to the purposes.

The first embodiment has a configuration including the air compressor that generates compressed air and stores the compressed air in the pressure container. However, the centrifuge may be configured to include an exchangeable pressure container which stores compressed gas in advance such that compressed gas is supplied from the pressure container into the chamber 5.

The present invention provides illustrative, non-limiting aspects as follows:

(1) In a first aspect, there is provided a centrifuge including: a rotary chamber; a rotor installed in the rotary chamber; a driving unit configured to rotate the rotor; a chamber accommodating the rotary chamber, having a door, and configured to house gas therein; and a vacuum pump apparatus configured to exhaust the gas inside the chamber to an outside of the chamber, wherein the chamber is provided with a plurality of gas inlets and a plurality of valves configured to respectively open and close the gas inlets, and wherein all of the plurality of valves are configured to be opened when bringing an internal pressure of the chamber to atmospheric pressure.

(2) In a second aspect, there is provided the centrifuge according to the first aspect, wherein any one of the gas inlets is configured to be supplied with compressed gas, and wherein the other gas inlet is configured to be supplied with gas in atmospheric pressure.

(3) In a third aspect, there is provided the centrifuge according to the second aspect, further comprising an air compressor including a pressure container, wherein the compressed gas, which is compressed air, is supplied from the pressure container to the gas inlet.

(4) In a fourth aspect, there is provided the centrifuge according to any one of the first to third aspects, wherein the chamber is provided with a check valve configured to seal the chamber when the internal pressure of the chamber becomes a decompressed state and exhaust gas inside the chamber when the internal pressure of the chamber becomes higher than atmospheric pressure.

(5) In a fifth aspect, there is provided a centrifuge including: a rotary chamber; a rotor installed in the rotary chamber; a driving unit configured to rotate the rotor; a chamber accommodating the rotary chamber, having a door, and configured to house gas therein; and a vacuum pump apparatus configured to exhaust the gas inside the chamber to an outside of the chamber, wherein the chamber is provided with a gas inlet and a valve configured to open and close the gas inlet, and wherein the gas inlet is configured to be supplied with compressed gas.

(6) In a sixth aspect, there is provided the centrifuge according to the fifth aspect, further comprising an air compressor including a pressure container, wherein the compressed gas, which is compressed air, is supplied from the pressure container to the gas inlet.

(7) In a seventh aspect, there is provided the centrifuge according to the fifth or sixth aspect, wherein the chamber is provided with a check valve configured to seal the chamber when an internal pressure of the chamber becomes a decompressed state and exhaust gas inside the chamber when the internal pressure of the chamber becomes higher than atmospheric pressure.

Also, arbitrary combinations of the above described components and modifications obtained by conversion of the present invention into methods and systems are also valid as embodiments of the present invention.

What is claimed is:

1. A centrifuge comprising:
a rotary chamber;
a rotor installed in the rotary chamber;
a driving unit configured to rotate the rotor;
a chamber accommodating the rotary chamber, having a door, and configured to house gas therein; and
a vacuum pump apparatus configured to exhaust the gas inside the chamber to an outside of the chamber,
wherein the chamber is provided with a plurality of gas inlets and a plurality of valves configured to respectively open and close the gas inlets, and
wherein all of the plurality of valves are configured to be opened when bringing an internal pressure of the chamber to atmospheric pressure.

2. The centrifuge according to claim 1,
wherein any one of the gas inlets is configured to be supplied with compressed gas, and
wherein the other gas inlet is configured to be supplied with gas in atmospheric pressure.

3. The centrifuge according to claim 2, further comprising an air compressor including a pressure container,
wherein the compressed gas, which is compressed air, is supplied from the pressure container to the gas inlet.

4. The centrifuge according to claim 1,
wherein the chamber is provided with a check valve configured to seal the chamber when the internal pressure of the chamber becomes a decompressed state and exhaust gas inside the chamber when the internal pressure of the chamber becomes higher than atmospheric pressure.

5. A centrifuge comprising:
a rotary chamber;
a rotor installed in the rotary chamber;
a driving unit configured to rotate the rotor;
a chamber accommodating the rotary chamber, having a door, and configured to house gas therein; and
a vacuum pump apparatus configured to exhaust the gas inside the chamber to an outside of the chamber,
wherein the chamber is provided with a gas inlet and a valve configured to open and close the gas inlet, and
wherein the gas inlet is configured to be supplied with compressed gas.

6. The centrifuge according to claim 5, further comprising an air compressor including a pressure container,
wherein the compressed gas, which is compressed air, is supplied from the pressure container to the gas inlet.

7. The centrifuge according to claim 5,
wherein the chamber is provided with a check valve configured to seal the chamber when an internal pressure of the chamber becomes a decompressed state and exhaust gas inside the chamber when the internal pressure of the chamber becomes higher than atmospheric pressure.
